(19) United States
(12) Patent Application Publication
(10) Pub. No.: US 2004/0215546 A1
(43) Pub. Date: Oct. 28, 2004

(54) Systems and methods for investment decision support

(75) Inventor: Cory Nelson, Corona, CA (US)

Correspondence Address: Squire, Sanders & Dempsey L.L.P., Two Renaissance Square, Suite 2700, 40 North Central Avenue, Phoenix, AZ, 85004-4498, US

(73) Assignees: Quicksilver Software, Inc.; Cashflow Technologies, Inc.

(21) Appl. No.: 10/830,837

(22) Filed: Apr. 22, 2004

Related U.S. Application Data
(60) Provisional application No. 60/465,210, filed on Apr. 24, 2003.

(51) Int. Cl. G06F 17/60

(52) U.S. Cl. 705/36

(57) ABSTRACT

A decision support computer system, according to various aspects of the present invention, is used by a plurality of users to learn principles of personal finance by competing. The system includes an engine for central processing; a network for communication between each user and the engine for central processing; an engine for identifying to a particular competition a subset of the plurality of users; an engine for modeling financial consequences of a respective series of decisions made by each user of the subset; a graphical user interface engine operative by each user for indicating a decision after associating values of an opportunity to portions of a financial statement; and an engine for recognizing a particular user of the subset as succeeding in the particular competition in response to determining that the particular user's decisions result in the accumulation of recurring passive income exceeding recurring expenses. Engine functions may be combined to reduce the number of independent engine implementations.

### CROSS-REFERENCE TO RELATED APPLICATIONS

This application claims benefit under 35 U.S.C. §120 to pending Provisional Patent Application S/No. 60/465,210 by Robert Kiyosaki, filed Apr. 24, 2003, incorporated herein by this reference.

### FIELD OF THE INVENTION

Embodiments of the present invention relate to systems and methods for decision support including, for example, systems and methods for teaching principles of finance, investing, and accounting.

### BACKGROUND OF THE INVENTION

Conventional decision support systems, such as computer automated systems for accounting and asset management, receive user input to select which of several presentations of information a user desires to review. Decisions (e.g., to purchase an asset) may be made off-line without input to the decision support system. Decision support systems include systems for training users in decision making.

Non-computer based systems of this type include board games for training players in making decisions. Conventional board games propose financial transactions to each player and provide incentives to win the game through efficient decision making to accept or decline participation in proposed transactions. Participation brings about a change in the players financial position as indicated, for example, by an income statement and balance sheet. Other incentives may include winning against competition from other players. These incentives motivate a player to learn preferred decision making techniques in spite of the difficulty of tracking changes in financial positions. Conventional board games for teaching financial skills to a player involve the player in writing financial values on an income statement, performing arithmetic to arrive at summary values, and writing the summary values on the income statement, all in response to game events.

A problem with respect to training decision makers is that there is no efficient user interface that focuses the user's attention on financial principles. A technical problem arises in that conventional computer automated decision support systems lack a method for a computerized calculation of a change in financial position that is responsive to user input of the type suitable for training decision makers. Conventional technologies for modeling a series of financial transactions require data entry by typing numerical values on a keyboard, using an on-screen calculator to arrive at intermediate or summary values, and copying the intermediate or summary values to various positions of an on-screen form for use in determining a change of financial position. For example, Quicken, marketed by Intuit Inc., includes a bookkeeping product that employs these technologies. These steps take time to complete and shift the focus of the user from the financial principles to the unguided mechanics of ad hoc numeric data entry. Consequently, decision making is slowed and teaching of financial principles is also hampered.

Without an improved user interface for decision support systems, improved decision making, especially for financial skills, cannot be rapidly taught.

### SUMMARY OF THE INVENTION

A computer system, according to various aspects of the present invention, permits participation in a financial transaction, the system includes an engine for presenting an opportunity to participate in the transaction, the opportunity comprising a plurality of values; an engine for providing a financial statement that describes a financial position, the financial statement comprising a plurality of portions, the financial position comprising total periodic income, total periodic expenses, and net periodic cash flow; an engine for receiving inputs from the user that specify each association of a plurality of associations, wherein each association associates a respective value of the opportunity with a respective portion of the financial statement; means for updating the presentation of the financial statement in accordance with the plurality of associations; and an engine for permitting participation in the transaction in accordance with accepting the plurality of associations. Engine functions may be combined to reduce the number of independent engine implementations.

A method, performed by a computer according to various aspects of the present invention, permits participation in a financial transaction, the method includes presenting an opportunity to participate in the transaction, the opportunity comprising a plurality of values; providing a financial statement that describes a financial position, the financial statement comprising a plurality of portions, the financial position comprising total periodic recurring passive income, total periodic recurring expenses, and net periodic cash flow; receiving inputs from the user that specify each association of a plurality of associations, wherein each association associates a respective value of the opportunity with a respective portion of the financial statement; updating the presentation of the financial statement in accordance with the plurality of associations; and permitting participation in the transaction in accordance with accepting the plurality of associations. In one implementation, a memory device includes indicia of instructions for a computer to perform the method.

A computer system for decision support, according to various aspects of the present invention, may be used by a plurality of users to learn principles of personal finance by competing. The system includes a central processor, a network, and a graphical user interface for each user. The network supports communication between each user and the central processor. Each graphical user interface presents output from the central processor and receives input from the user for identifying to a particular competition a subset of the plurality of users, for modeling financial consequences of a respective series of decisions made by each user of the subset; and for recognizing a particular user of the subset as succeeding in the particular competition in response to determining that the particular user's decisions result in the accumulation of periodic recurring passive income exceeding periodic recurring expenses.

A method, according to various aspects of the present invention, encourages financial decision making by a user. The method includes presenting values to a user spatially distributed in a presentation; receiving a signal from a device operated by the user, the user responding to the presentation; classifying each value of the plurality of values according to the signal, a plurality of user-specified classifications, each classification for a respective value of the plurality of values according to a respective class of the set comprising classifications according to generally accepted accounting principles; and providing visual and/or auditory guidance to the user in accordance with the associations, to encourage the user to classify the values according to a predefined classification or to accumulate recurring passive income to exceed recurring expenses. In one implementation, a memory device includes indicia of instructions for a computer to perform the method.

A computer system, according to various aspects of the present invention, includes an output device for presenting information to a user, a presentation of the information including values; an input device operative by the user to provide a signal; and a processor coupled to the output device and to the input device for communicating with the user, wherein the processor, in accordance with the signal, associates each value of the plurality of values with a type of value being of the set comprising periodic recurring passive income and periodic recurring expenses; and the processor provides guidance to the user in accordance with the associations, to encourage the user to classify the values according to a predefined classification or to accumulate periodic recurring passive income to exceed periodic recurring expenses.

A decision support computer system, according to various aspects of the present invention, is used by a plurality of users to learn principles of personal finance by competing. The system includes an engine for central processing; a network for communication between each user and the engine for central processing; an engine for identifying to a particular competition a subset of the plurality of users; an engine for modeling financial consequences of a respective series of decisions made by each user of the subset; a graphical user interface engine operative by each user for indicating a decision after associating values of an opportunity to portions of a financial statement; and an engine for recognizing a particular user of the subset as succeeding in the particular competition in response to determining that the particular user's decisions result in the accumulation of recurring passive income exceeding recurring expenses. Engine functions may be combined to reduce the number of independent engine implementations.

### BRIEF DESCRIPTION OF THE DRAWING

Embodiments of the present invention will now be further described with reference to the drawing, wherein like designations denote like elements, and:

FIG. 1 is a functional block diagram of a system according to various aspects of the present invention;

FIG. 2 is a functional block diagram of an engine for use in a system of the type shown in FIG. 1;

FIG. 3 is a data flow diagram of a multi-user process according to various aspects of the present invention;

FIG. 4 is a data flow diagram of a process for interacting with a user regarding an opportunity in a process of the type shown in FIG. 3;

FIG. 5 is a plan view of a presentation used by a process of the type shown in FIG. 4; and

FIG. 6 is a data flow diagram of a process for associating opportunity values with a statement of the types shown in FIGS. 4 and 5.

### DETAILED DESCRIPTION OF THE PREFERRED EMBODIMENTS

A decision support system, according to various aspects of the present invention, may be used as a simulator, used for teaching financial principles, used as a game, or used for determining compensation for the user of the decision support system. Such a system may be implemented as a stand alone station (e.g., for use by one or more users in turn); or as a network of clients and/or servers. Conventional client/server and client/client technologies may be used. Stand alone implementations include general purpose computers (e.g., lap top, desk top, palm top, cell phone) having user interfaces; and include general or special purpose gaming devices having interfaces to use a conventional television set as a display and any conventional gaming user interface unit (e.g., hand held joy stick and gaming push button switches).

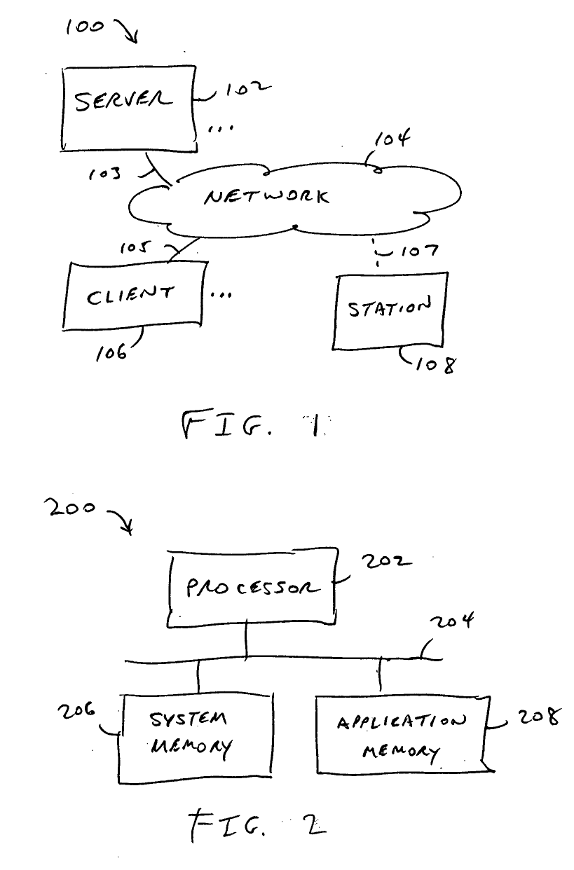

For example, system 100 of FIGS. 1-5 includes server 102, network 104, client 106, and station 108. Server 102 represents any number of computer systems having conventional software for coupling to a network (e.g., the Internet) via a conventional link 103 and software for teaching as discussed herein. Client 106 represents any number of computer systems having conventional software (e.g., a browser) for communicating with one or more servers via a conventional link 105. In one implementation servers are omitted and clients communicate with each other using conventional technology and software installed on one or both clients for teaching as discussed herein. Links 103 and 105 support signals for transferring (e.g., downloading) software and for conveying messages between processes to accomplish methods discussed herein. In another implementation, client 106 includes a conventional browser (e.g., Internet Explorer marketed by Microsoft) and server 102 includes all decision support software (e.g., except for conventional cookies and applets as may be used by the browser).

Station 108 represents any number of computer systems, each operating independently of all other entities shown in FIG. 1. A station 108 may communicate with other servers, clients, or stations via network 104 temporarily via link 107 as desired (e.g., product registration, download of software and updates, sharing of usage reports, or training progress reports). A stand alone station 108 in one implementation includes processes of server 102 adapted using conventional techniques to operate without a network and with the user interface of station 108 (e.g., computer monitor, LCD cell phone display, television set).

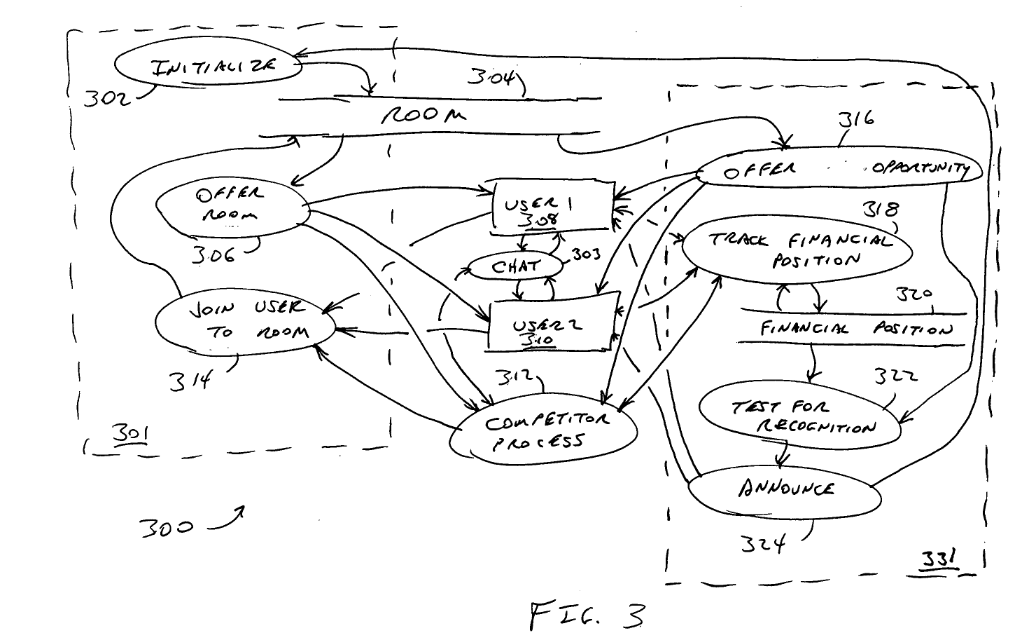

Processes performed by computer systems (e.g., servers, clients, and stand alone stations) of FIG. 1 may be performed by one or more engines. An engine includes any circuit, firmware, and software for performing stored program instructions. The logic of the process may be performed to any extent by circuitry and/or program instructions. For example, engine 200 or FIG. 2 includes a processor 202, bus 204, system memory 206, and application memory 208. Engine 200 may include interfaces (not shown) to conventional peripherals such as displays and keyboards. A server 102 includes any number of engines 200 and may omit peripherals (except possibly for administrative control of a server). A client 106 or a station 108 may include any number of engines 200 and interfaces for user interaction with teaching software discussed herein. Memory (206, 208) may include any combination of conventional memory devices (e.g., disks, CDROMs, semiconductor RAM, EPROM) and may be divided as shown to simplify use of the engine for application programs different from training software described herein. For example, application memory may be packaged as a game module to be inserted into a station (e.g., a Microsoft XBox). In one implementation, a game module includes an engine 200 programmed to perform teaching software as discussed herein. In another implementation, engine 200 is formed on a semiconductor substrate.

Methods according to various aspects of the present invention teach a user skills for improved investing as discussed above. These methods may be implemented with any number of user processes and competitor processes and at a minimum include one user process and no competitor processes. System 100 conducts any number of sessions simultaneously, each session comprising a context for competition among users (if more than one) and competitor processes (if any). In an implementation discussed below, system 100 provides in each session a decision support system as discussed above; and, among other functions, presents opportunities for transactions. A user process presents hypothetical opportunities, reports, and descriptions of financial positions; and, responds to inputs from the user to perform simulated transactions. A competitor process manages a unique financial position that changes to simulate the actions and responses of a hypothetical user competing against the human user. A competitor process performs automatically the operations of a hypothetical user having a selected level of skill. Each competitor process may have the same or a different level of skill relative to the human user(s) of the session and relative to other competitor processes of the session. A respective financial position is maintained for each competitor process. Each competitor process makes independent decisions on opportunities and/or defined transactions.

Transactions may include acquiring real estate, acquiring businesses, and/or acquiring stock. A transaction may include a mortgage or loan to finance acquisition. The user's decision culminates in a buy/sell order received by system 100.

A user process interacts with a conventional user interface (not shown) in any conventional manner. The user process and user interface may be performed by (i.e., hosted on) the same engine or different engines may be in communication in any conventional manner (e.g., shared memory, operating system calls, remote procedure calls, protocol stacks, message handlers, and/or via links and networks). As discussed below, processes may be responsive to user input and provide presentations for user review by interacting with input devices (e.g., keyboards, pointing devices, touch screens) and output devices (e.g., monitors, LCD displays), interacting with a conventional user interface, or interacting with communication software (e.g., interacting in a platform independent way with a browser that cooperates with platform specific input and output devices).

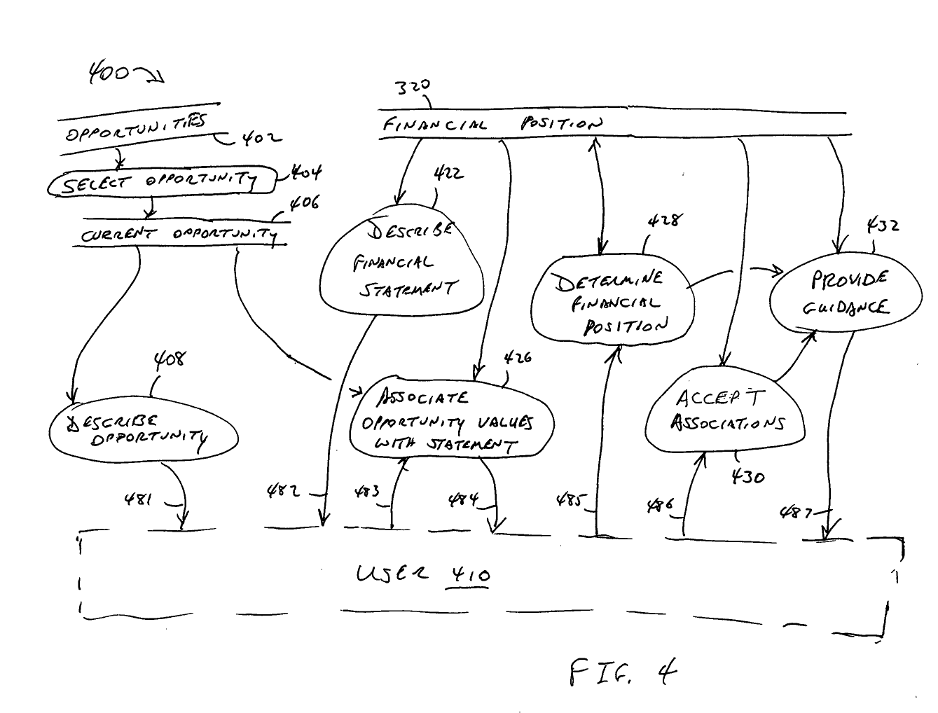

For example, user process 300, of FIG. 3, includes initialize process 302, room store 304, offer room process 306, competitor process 312, join user to room process 314, offer opportunity process 316, track financial position process 318, financial position store 320, test for recognition process 322, and announce process 324. These processes may be performed by engines implemented on servers as discussed above (e.g., web servers, lobby servers, chat servers, and business servers). A web server in one implementation includes conventional hardware and software for communication with client browsers via the Internet and may include database software for retrieval of web pages as well as formatting software for preparing web pages from information stored in a database. A lobby may perform all processes for organizing users into groups (also called rooms) for competition among members of the group including processes 301 of FIG. 3. Each group may have a unique context of transactions for users of the group. A chat server may perform chat process 303 for communication between users of a group. And, a business server (also called a game server) may perform all other processes of decision support system 100.

An initialize process prepares system 100 for solo or competitive decision support. For example, initialize process 302 prepares storage for associating particular users to a each particular group for simultaneous multi-threaded operation of system 100 with one or more independent groups each having one or more users. When session(s) for one or more users terminate, process 302 may discard information about the unique group of users and the unique context of transactions associated with that group.

A room store provides storage and indexed access for the identities of users that compete with each other. The group may include human users and competitor processes that use conventional artificial intelligence techniques to implement a predefined strategy. Competition may begin after a desired number of users have been associated with a group. Association may derive from the metaphor of “entering” a “room” by (a) identifying the user (e.g., user logs in and identifies himself or herself); (b) displaying the identities of other users to encourage grouping (e.g., coordinated by a conventional chat facility); (c) associating the user to a room (e.g., creating a room record because a user has expressed a desire (by default or by response to advertised availability and selection) to be associated with any group, or a particular group, for competition; and (c) periodically testing whether a desired number of users are associated (e.g., that a desired number of records for the group exist). Testing may be manual by a designated human user (e.g., a captain); or automatic (e.g., time lapse or maximum number in the room). For example, room store 304 includes a record for each user-room association and is accessible by user name or by room name. Room store 304 may further include status of each user in the room, status of the competition in the room (e.g., scores), and status of the room activity (e.g., awaiting competition to begin, competition in progress, room ready to be vacated, room empty).

An offer room process advertises the availability of competitions to users. In response a user may enter the room as discussed above. For example, offer room process 306 reviews records from room store 304 and sends messages about rooms to users (e.g., user1 308, user2 310) and competitor processes (e.g., process 312). Offer room process 306 may selectively offer rooms to particular users and competitor processes to assure vigorous competition among similarly skilled users and processes. Room store 304 may include information to guide such selective offering including for example descriptions of users (e.g., number of competitions, number of successes, apparent strategy of a set of strategies). Each competitor process may have a characteristic named strategy. If a human user participates in transactions in a manner similar to a named strategy, the named strategy may be associated with the user as an apparent strategy.

A competitor process cooperates with transactions to participate in transactions initiated by others and/or to initiate transactions. For example, competitor process 312 represents any number of instances of competitor processes, each implementing a strategy as discussed above. In one implementation, a set of predefined strategies are available to any instance (e.g., in a multi-threaded processing environment) of a competitor process; and a competitor process selects a strategy and uses that strategy throughout a competition. In another implementation, a competitor process shifts from one strategy to another of the set in response to the apparent strategies of the other users in the group to resemble a user who is learning better strategy from watching the transactions of others.

A join user to room process associates a user or a competitor process to a group as discussed above. For example, join user process 314 receives responses to advertisements from user1 308, user2 310, and competitor process 312. Suitable records of room store 304 are prepared and/or updated to indicate joinder (e.g., entry into a room and acceptance to compete with those in the room).

An offer opportunity process presents an opportunity to participate in a particular financial transaction. The presentation may include a description of any conventional transaction to any one, subset, or all users in the room. An opportunity may include a purchase, sale, barter, lease, or mortgage of any valuable item, typically an investment in an item whose value may be different at some time in the future of the competition (e.g., real estate, commodities, collectables, personal property, intellectual property, stock, a business, a partnership in a business, options, commercial paper). By presenting opportunities for transactions, user process 300 provides information that may be used for practicing decision making by each user. For example, offer opportunity process 316 may provide user 308 with an opportunity to buy a house by sending a description of a conventional purchase transaction (e.g., description of the property, down payment, cost, mortgage, closing costs, closing date, cash flow (e.g., periodic net of income such as rent and expenses such as interest expense on the mortgage)). An opportunity defined by a user or a competitor process is herein called a defined transaction.

A track financial position process maintains a financial position for each user and competitor process in a competition. Tracking may include establishing an initial financial position; providing information about the current financial position of a user to any or all users and competitor processes; and updating the financial position in response to buy/sell orders from users and competitor processes. For example track financial position process 318 creates, revises, and deletes records of financial position store 320 in any conventional manner.

A financial position store maintains information that describes the financial position of a user or a competitor process. For example, financial position store 320 includes one or more records for each unique financial position for process 300. These records may be indexed by any combination of room name, user name, and competitor process instance identifier allowing the same user to be in more than one room with unique financial positions for each competition. In one implementation, information in such records is sufficient to describe for each user (or competitor) a conventional income statement and balance sheet of the type used according to generally accepted accounting practices (GAAP). In a preferred implementation, an opportunity and a financial position are simplified and include only information of the type described for an opportunity and a financial statement in U.S. Pat. No. 5,826,878 to Robert Kiyosaki.

A financial position includes parameters consistent with GAAP. For example, a financial position may include information of a conventional or simplified income statement and balance sheet. In one implementation, only those parameters stated in Table 1 are used so that training using system 100 is relatively efficient.

TABLE 1

| Group | Parameter of a Financial Position |
|---|---|
| Income statement - | Salary; Interest; Dividends; Real estate cash flows; |
| Income | Business cash flows; Passive income |
| | (all income except salary); |
| Income statement - | Taxes; Payments for mortgages and loans; |
| Expenses | Lumped expense related to raising children |
| | (e.g., the product of a fixed expense |
| | and the number of children); |
| Balance sheet - | Savings; Symbol, number of shares, and cost per |
| Assets | share of stock, mutual fund, or certificate of deposit; |
| | Real estate type, down payment, and total cost; |
| | Business type, down payment, and total cost; |
| Balance sheet - | Initial principle amount of each mortgage and loan; |
| Liabilities | Business liability; |

Cash flow as used in different contexts herein means either an asset's cash flow or a user's (or competitor process's) cash flow. An asset's cash flow means the net income or expense of holding an asset (e.g., rental income or loss from real estate after maintenance and all other expenses). A user's cash flow means the sum of a user's (or competitor process's) salary and all asset cash flows (positive and negative) minus the sum of all expenses.

A test for recognition process determines when and how to recognize the suitable or unsuitable reaction of a user to an opportunity (or series of opportunities). For example, process 322 may review financial positions described in store 320 and opportunities (current and historical) offered by process 316, and, using conventional logic, provide an announcement to one or all users regarding whether or not a condition exists for recognition of one or more of the users or competitor processes. Tests may be made for suitable announcements (e.g., coaching) prior to the user's decision on an opportunity, for reinforcing suitable decision making (e.g., negative remarks triggered when transactions are accepted that are not consistent with a suitable strategy, and positive remarks triggered when transactions are consistent with a suitable strategy), or for announcing the end of a competition (e.g., a user “wins” or “loses” a competition as a whole) for a particular user. Strategies may be for personal finance (e.g., the accumulation of wealth for financial independence or retirement).

An announce process provides a suitable announcement to one or more users as directed by the test for recognition process discussed above. The announcement may include text, audio, graphics, video, and/or animation using any conventional technique. For example, announce process 324 provides a percent of goal indicator to each user (308, 310) where each user's goal is to have passive income exceed expenses. Process 324 also provides congratulatory announcements on this occurrence and on transactions that move toward that goal. After an announcement is acknowledged (or lapse of time), announce process 324 may advise initialize process 302 so that process 302 may make any suitable change to room store 304, for example, to remove a user from a room (e.g., a “winner” or a “loser”) or to remove all users from a room (e.g., competition is over). Announcements may be made via chat process 303 receiving input (not shown) from announce process 324.

A competitor process may participate in a chat with other users. A chat may include the offer by one user or competitor process an opportunity of the type described above with reference to offer opportunity process 316. For example, process 303 may receive input and provide output between itself and any competitor process 312. For instance, a player having an asset may offer to sell the asset to another user or competitor process, or a user may conduct an auction of the asset among other users and competitor processes.

Functions of user process 300 may be implemented on a client (or station) and/or on a server (for clients) as discussed above. When implemented on a client 106 (or station 108), user process 300 (with user 310 omitted) may support sessions involving: (a) one user (process 312 is omitted); (b) one user and one or more competitor processes; (c) several users taking turns using one user interface (process 312 is omitted); or (d) one or more competitor processes and several users taking turns using one user interface. When implemented on a client 106 (or station 108), user process 300 may cooperate with a process (not shown, also called a pseudo server) performed by the client (or station) that performs functions ordinarily performed by a server when the client is in communication with a server. For example, server 102 (or a pseudo server) may perform processes 301 and maintain room store 304, all other processes of process 300 being performed by one or more clients 106. Further, processes 331 may be performed: (a) by server 102 (or a pseudo server); (b) by client 106; or (c) divided between a server and a client. As an example, by hosting process 316 on server 102, synchronizing several independent instances of process 316 may be simplified or omitted. By supporting most functions of user process 300 on client 106, communication to and from server 102 may be simplified and for many purposes omitted.

According to various aspects of the present invention, interaction between a user process as discussed above with reference to process 300 may include a sequence of associations, directed by the user, that reinforce financial principles to be learned by the user. Each association may be understood as an action by which a user classifies each value according to a predetermined system of classification. A system of classification may include a set of classes, each class for describing or grouping values. A system of classification may be hierarchical and may be evident from a presentation of a financial statement. For example, classes may include income from salary, passive income, expense cash flow, asset cost, asset down payment, and liability cost, to name a few.

As discussed above, a user responds to the presentation of an opportunity with among other things a buy/sell order. A buy/sell order indicates his or her authorization to complete the transaction(s) described in the opportunity. The buy/sell order may direct buy, sell, or pass on a current opportunity; direct selling the current opportunity to another user (or competitor process); direct putting the current opportunity up for auction among users and/or competitor processes; may further include a specification of a defined transaction to complete (e.g., an ad hoc order to liquidate an asset, pay off a loan, participate in an auction, make an offer to another user (or competitor process)); or direct a response to an offer from another user (or competitor process).

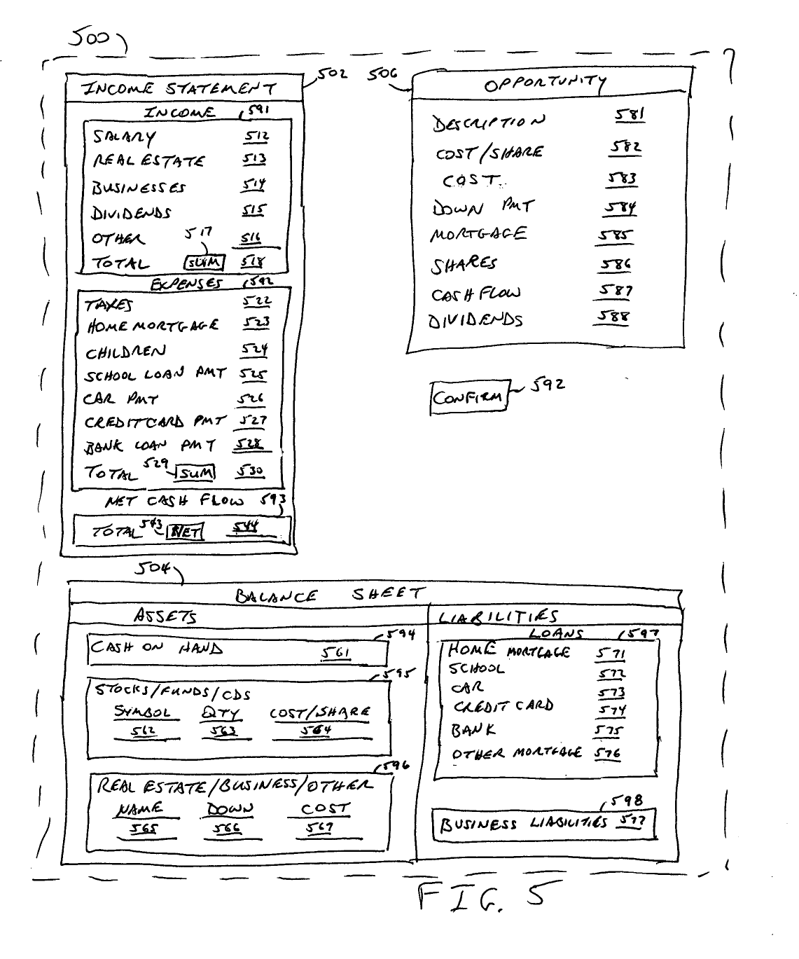

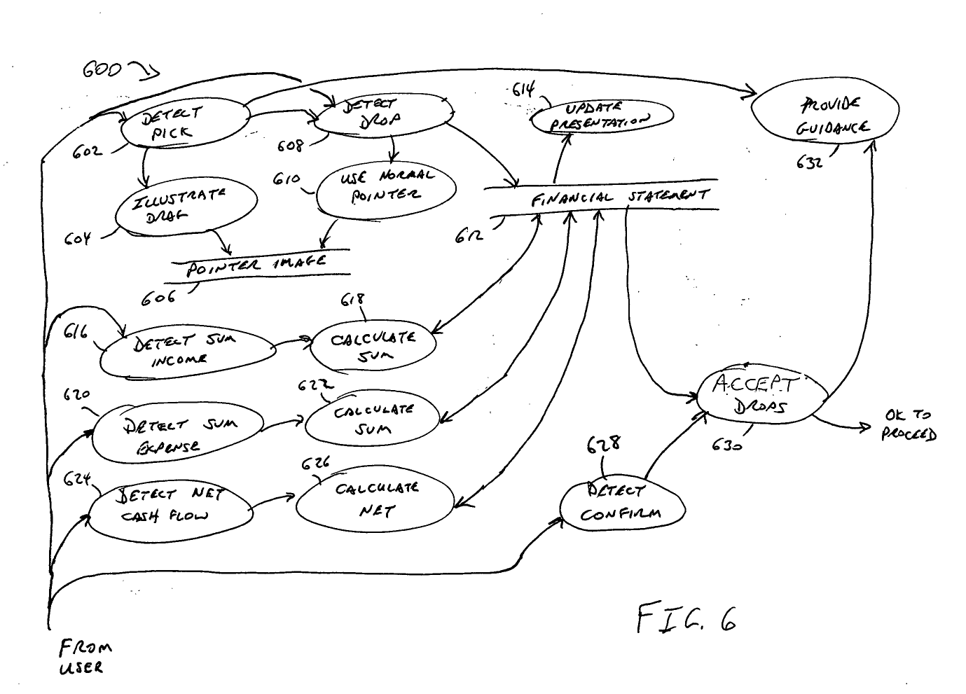

A process for user interaction, according to various aspects of the present invention, includes describing an opportunity and accepting user directed associations. For example, process 400 of FIG. 4 prepares a presentation 500 of FIG. 5 for user 410. Process 400 includes opportunity store 402, select opportunity process 404, current opportunity store 406 describe opportunity process 408, financial position store 320, describe financial statement process 422, associate opportunity values with statement process 426, determine financial position process 428, accept associations process 430, and provide guidance process 432. Interaction between these processes and user 410 (data flows 481-487) may be implemented using any conventional technology, including conventional interprocess communication (e.g., cooperating with operating systems, drivers, or queues), network communication (e.g., cooperating with conventional stacks such as TCP, HTTP, and HTML), and direct control of input/output devices (e.g., keyboard, mouse, and display).

Generally, opportunities store 402, select opportunity process 404, current opportunity store 406, and describe opportunity process 408 cooperate to offer an opportunity as discussed with reference to process 316 above. An opportunities store provides storage for a plurality of opportunities regarding transactions for users and competitor processes involving any item or items from any market or markets. An opportunity may be fixed or dynamic. A fixed opportunity may be stored as a set of parameter values. A dynamic opportunity may include a stored algorithm (or reference to an algorithm) to be applied to current financial positions to provide a dynamically defined opportunity. For example, opportunities store 402 provides fixed opportunities on request by select opportunity process 404.

Each opportunity of store 402, for instance, is of a type described in Table 2. In Table 2, binary values are indicated T/F for true or false. Currency is indicated in dollars, though any currency may be used. Values in quotes are exemplary. An opportunity may include a recurring expense (e.g., a loan payment) a recurring income (e.g., rent), and/or an expense (e.g., a tax, management fee, repairs) that may become due according to a hypothetical event (e.g., after a predetermined time, a time triggered by other events, or a random time) to simulate annual taxation or irregular repairs. An opportunity may affect any of the parameters described below with reference to financial position 320.

TABLE 2

| Type of Opportunity | Parameters and Example Values |
|---|---|
| Expense | Mandatory T/F; Charitable T/F; |
| | Description = “Buy a yacht.”; Cost = “$30,000”; |
| | Down Payment = “$5,000”; |
| | Mortgage = “$25,000”; Cash Flow = “−$500”; |
| | Annual Expense = “$150”. |
| Stock | Symbol = “OK4U”; Market = “NYSE”; Number |
| | of shares = “500” (or from user); Price per |
| | share = (from Prices 340); type of |
| | transaction = “short”; Dividends = “0”; Delay till |
| | settlement = “6 market intervals”; Projected |
| | ROI (Return on Investment). |
| Real Estate | Description = “Apartment Building”; |
| | Market = “Small Town”; Cost = “$300,000”; |
| | Down Payment = “$50,000”; Projected ROI; |
| | Mortgage = “$250,000”; Cash Flow = “+$4,500”. |
| Loan | Description = “Unsecured”; Cost = “$10,000”; |
| | Down Payment = “$0”; Cash on |
| | hand = “$10,000”; Cash Flow = “−$100”. |

Select opportunity process 404 identifies an opportunity as the current opportunity 406. Identification may be by copying the opportunity from store 402 to store 404; or by storing a pointer in store 404 for access to the identified opportunity of store 402. Selection may be according to a random selection, according to a fixed series, or according to a dynamic series based on financial positions 320. Selection may be directed (e.g., supplanted) by a message received from an offer opportunity process 316 performed by a server, as discussed above.

Describe opportunity process 408 provides information about one or more opportunities for presentation to the user or a competitor process. In the opportunity, references to information to be supplied by the user (e.g., desired number of shares) and references to current market price are added to the provided information by process 406. Market price may be determined by process 408 in any conventional manner. For example, presentation 500 includes 506 for an opportunity. Region 506 suitably includes: a value 581 for the description of the asset involved in the opportunity (e.g., stock symbol OK4U, house having 3BR/2BTH); a value 582 for cost per share (omitted for real estate opportunity); a value 583 for total cost; a value 584 for down payment (if purchase financing is part of the opportunity); a value 585 for an amount financed after down payment is accounted for (if purchase financing is part of the opportunity); a value 586 for the number of shares in the opportunity (e.g., may be fixed or user specified for stock opportunities, omitted for real estate opportunities); a value 587 for a cash flow (positive or negative) associated with the property (omitted for stock opportunities); and a value 588 for dividends (omitted for real estate opportunity).

Describe financial statement process 422 provides information about a financial position for presentation to the user or a competitor process. A financial statement is a presentation that describes a financial position. A financial statement may include an income statement and a balance sheet as discussed above. For example, presentation 500 includes region 502 for an income statement and region 504 for a balance sheet. Region 502 includes a subordinate region for each of income 591, expenses 592, and net cash flow 593. The subordinate region for income 591 includes a value 512 for salary; a value 513 for positive cash flows from real estate (a list of properties and cash flow for each property may be included next to the summary entry); a value 514 for positive cash flows from businesses (a list of businesses and cash flow for each business may be included next to the summary entry); a value 515 for dividends from stock, mutual funds, and certificates of deposit (CDs) (a list of stocks, funds, and CDs and dividends for each may be included next to the summary entry); a value 516 for other sources of income, and a button 517 activation of which by the user updates a total value 518 of values 512 through 516. The subordinate region for expenses 592 includes a value 522 for taxes; a value 523 for home mortgage payment; a value 524 for expenses related to the number of children in the user's family; a value 525 for school loan payment; a value 526 for car payment; a value 527 for credit card payment; a value 528 for bank loan payment (used to pay nonrecurring expenses or fund purchase of opportunities), and a sum button 529 activation of which by the user updates a total value 530 of values 522 through 528. The subordinate region for net cash flow 593 includes a net button 543 activation of which by the user updates a net cash flow value 544 of total income 518 minus total expenses 530.

Region 504 may be divided into a column for assets and a second column for liabilities. Assets may include subordinate regions for different types of assets. For example, a subordinate region for cash on hand 594 includes a value 561 for liquid funds available for purchasing opportunities. A subordinate region for stocks, mutual funds, and CDs 595 includes a list, each row including a value 562 for the symbol or description of the stock, mutual fund, or CD; a value 563 for the quantity of shares owned; and a value 564 for the cost per share. A third subordinate region for real estate, businesses, and other assets 596 includes a list, each row including a value 565 for a name of the asset; a value 566 for the down payment used to purchase the asset; and a value 567 for the cost of the asset. Liabilities may include subordinate regions for different types of liabilities. For example, a subordinate region for loans 597 includes a value 571 for home mortgages; a value 572 for school loans; a value 573 for car loans; a value 574 for credit card loans; a value 575 for bank loans; and a value 576 for other mortgages. A second subordinate region 598 includes a value 577 for business liabilities.

A process for associating values of an opportunity with a financial statement is implemented to require a user to recognize distinctions between at least two values and to take a different action with each respective value based on the distinction. Values may be provided in the description of the opportunity or may be the result of summarization of the user's financial position before or after taking into account an effect of the opportunity. Actions may be any conventional action of a user interface, such as pointing using a pointing device for identifying and/or dragging (i.e., pressing a button on the pointing device on a first location of the presentation, moving the pointing device to relocate the pointer to a second location of the presentation, and releasing the button on the pointing device on a second location of the presentation). Actions may differ in that a drag is accomplished to different locations for different values. Alternative implementations may use other user actions and may modify the presentation in any conventional manner in response to user actions to indicate that an association is in progress or has been accepted or denied.

An association of a value with a portion of a financial statement may be specified by a user using a conventional user interface (e.g., a graphical user interface). After identifying a particular value, the user may identify the particular portion of the financial statement for the association. Alternatively, after identifying a particular portion of the financial statement, the user may identify the particular value for the association. During the time between the first act of identifying and the second act of identifying, the first identified item may be presented in a manner that indicates that it has been identified for an association. Any conventional manner may be used (e.g., change of color, change of background around the item, changing the appearance of the item in situ, copying or moving the item to a distinguished portion of the presentation, flashing the item, animation of the item, or animation distinguishing the item).

For example, associate values of opportunity with financial statement process 426 may form associations according to specifications and requests received (483) from user 410. Process 426 may provide information (484) to the user (or any process ultimately providing a presentation to the user) as an animation (dragging the dollar value) as the user performs ad hoc specifications of associations. Each specification may involve a drag from a location in the opportunity presentation 506 to a drop in a location in the financial statement 502 and 504. The location may have a characteristic legend visually associated with the location (e.g., a row heading, a column heading, a caption). The drop may appear to associate the value with the location, or with the legend. For instance, if opportunity 506 described a real estate purchase, the user having presentation 500 on screen, may perform the following operations in any order: (a) dragging from down payment (legend or value 584) to subordinate region 596 legend “down” or value location 566; (b) dragging from cost (legend or value 583) to subordinate region 596 legend “cost” or value 567; (c) dragging mortgage (legend or value 585) to subordinate region 597 legend “other mortgage” or value 576; and (d) dragging cash flow (legend or value 587) to subordinate region 591 legend “real estate” or value 513. The user has thereby demonstrated a knowledge of the terminology of a financial opportunity (or transaction), has distinguished values of the opportunity from each other and from various (incorrect) entries of the financial statement, and has associated values of the opportunity to respective correct entries of the financial statement. Here, down payment is distinguished from other values and the user has taken action to associate the down payment value of the opportunity to the down payment entry of the real estate assets portion of the balance sheet.

At any time and at least once after the associations made by process 426, the user provides input to determine financial position process 428. An updated income portion (591) of income statement 502, as discussed above, is provided by process 428 (and 422) in response to the user activating sum button 517. Operation of sum button 517 initiates a request 485 for an update of value 518 to reflect the sum of values 512-516. An updated expense portion (592) of income statement 502, as discussed above, is provided by process 428 (and 422) in response to the user activating sum button 529. Operation of sum button 529 initiates a request 485 for an update of value 530 to reflect the sum of values 522-528. An updated cash flow portion (593) of income statement 502, as discussed above, is provided by process 428 (and 422) in response to the user activating net button 543. Operation of net button 543 initiates a request 485 for an update of value 544 to reflect income 518 minus expenses 530.

An accept associations process, may determine whether an association or an updated financial statement is consistent with generally accepted accounting standards (GAAP) and/or is consistent with a desired strategy (e.g., a generally accepted strategy for personal finance). At any time the user may indicate that the user is satisfied that presentation 502 and 504 as showing a properly updated financial statement. For example, operation of confirm button 592 initiates a request 486 to accept associations process 430. For example, accept associations process 430, detects each association of a value with a respective entry of the financial statement that is not consistent with financial principles (e.g., GAAP and/or a strategy for personal finance) and directs a suitable output by provide guidance process 432.

Guidance may be provided to the user in any conventional form and format. For example, provide guidance process 432 provides audio messages accompanied by a presentation of animated characters. Guidance may also include a short lesson. A lesson may be presented in audio and video as a conventional lecture to the user. Guidance may be triggered by proper or improper associations (e.g., a data flow from process 426 to process 432). Guidance may be triggered by a premature request for, a or correct completion of, determining financial position (e.g., a data flow from process 428 to process 432).

In one implementation, the user decides whether to accept the opportunity prior to forming the associations discussed above. Alternatively, the user may specify the associations and, based on the resulting financial statement and/or guidance provided by process 432, decide whether to accept or reject the opportunity. In other words, the user may issue a buy/sell order to system 100 (e.g., to process 318; or as request 485 to process 428) before or after operation of confirm button 592 discussed above. Presentation 500 may include any suitable buttons for a user to specify a suitable buy/sell order.

In response to a buy/sell order, the financial position of the user may be updated by determine financial position process 428. Process 428 may apply GAAP to update the respective financial position of each user and competitor that may be affected by one or more buy/sell orders involved in a single transaction. For example, when an asset is sold by one user (or competitor process) and purchased by another user (or competitor process), both the buyer's and seller's respective financial positions are updated.

Processes discussed above with reference to FIGS. 3 and 4 may operate in a multi-threaded manner to support numerous sessions, each session preserving a state for all users and competitor processes of the respective session. Although sets of opportunities 402 may be common to all sessions, each session will typically have its own unique instance of current opportunity 406 and financial position store 320.

A method for receiving the specifications for associations discussed above may be implemented to support ad hoc actions by the user. For example, method 600 of FIG. 6 includes detect pick process 602, detect drop process 608, detect sum income process 616, detect sum expense process 620, detect net cash flow process 624, and detect confirm process 628 that receive a signal from the user (or a process such as a driver or operating system between these processes and the user). These processes may operate in parallel to support receiving any input from the user at any time; and receiving a series of inputs from the user in any order. Method 600 further includes illustrate drag process 604, pointer image store 606, use normal pointer process 610, financial statement store 612, update presentation process 614, calculate sum process 618, calculate sum process 622, calculate net process 626, accept drops process 630, and provide guidance process 632. These processes perform the functions discussed above with reference to FIG. 4.

A presentation may include a background image and a foreground image. The foreground image may include an indication (e.g., an arrow) associated with operation of the pointing device of the user interface. As the pointing device is moved about, the foreground image floats over the background image in the presentation in any conventional manner. When a value is specified to be dragged, the foreground image may be amended to include a presentation of the value. For example, if the value for cash flow, e.g. −$200 for minus two hundred dollars, is dragged, pointer image 606 is amended by process 604 to include the characters “−$200” beside the arrow to float with the arrow until dropped. When a value is dropped, pointer image 606 is returned by process 610 to its prior state (e.g., an arrow without accompanying numbers).

Process 614 updates the background image of the presentation with new numbers, as discussed above. For example, after a value is dropped, the original presentation of the value (in opportunity 506) may be presented as zero or in a different color. Dropping a value may involve computing a cumulative sum at the dropped location of the presentation. For example, real estate value 513 may include $300 of income from owned properties prior to dropping the −$200 cash flow mentioned in the preceding paragraph and then be revised by process 614 after the drop to show the cumulative sum $100. In an alternate implementation, negative cash flows must be associated with the expense portion rather than income portion of the financial statement.

Method 600 may continue until accept drops process 630 provides a signal to proceed (e.g., “OK to proceed” with participation in the transaction, with completing the transaction, or proceed to next opportunity or event). In other words, the user may be afforded several rounds to successfully associate values with the financial statement. In one implementation, if the values of the opportunity are not properly associated with the financial statement in a predetermined number of attempts (e.g., 3 operations of confirm button 592) or in a predetermined duration (e.g., 30 seconds), accept drops process 630 provides a signal as if the user had decided to “pass” on the opportunity. The signal provided by accept drops process 630 may be a buy/sell order as discussed above. Acceptance may be as described for process 430 above.

In one implementation, the current opportunity includes for each value that may be specified for an association (e.g., 581-588) an item identifier (item ID), a text string for the value (e.g., “$200”), a binary value used for arithmetic involving the value, a destination category, a destination subcategory, and a destination sub-subcategory. The destination for the value identifies the portion of the financial statement to which the value is to be properly associated. In a hierarchy, a category may include one or more subcategories and each subcategory may include one or more sub-subcategories. For example, value 582 is described in opportunity 506 as cost per share for a stock, mutual fund, or certificate of deposit. The destination category for value 582 corresponds to balance sheet assets; the subcategory corresponds to stocks/funds/CDs region 595; and the sub-subcategory corresponds to cost/share column 564.

Each portion of the presentation of the financial statement may have a category, subcategory, and sub-subcategory. In this way, the hierarchical destination category (e.g., provided by detect pick process 602) may be compared by process 630 to the hierarchical location category (e.g., provided by detect drop process 608) to determine whether the drop is accepted. In an alternate implementation, a portion and/or a value may have a set of more than one subcategory and/or more than one sub-subcategory to facilitate presentation of both correct and incorrect drops; and for acceptance of suitable drops. Update presentation process 614 operates according to the following rules. In cases where the drop specifies an incorrect destination, the value may appear to jump to the nearest location that satisfies the following rules. In such a case, the pointer image may be moved as well, to draw attention to the location that satisfied the rules.

If a drop identifies in the presentation of the financial statement a location having a location category, subcategory (if any), and sub-subcategory (if any) corresponding to the destination category, subcategory (if any), and sub-subcategory (if any), the association is accepted.

If a drop identifies in the presentation of the financial statement a location that corresponds to the destination category, subcategory, and sub-subcategory, and no row exists matching the item ID (e.g., the stock symbol), then a new row in a list may be created and tagged with the item ID. In this way, the cost per share specification may be completed prior to the specification of the quantity of shares (QTY 563). When the quantity of shares value 586 is dropped properly, no new row in the list is needed and the value is placed in the same row of the list with the symbol and cost/per share value from the first drop.

If a drop identifies in the presentation of the financial statement a location that does not correspond to the destination category, then the drop may be completed into a region of the location that corresponds to the subcategory. In this way, a mortgage associated with real estate in the opportunity (585) if dropped in balance sheet assets instead of where it belongs (balance sheet liabilities), the value will be associated with an otherwise matching (or near match) subcategory (e.g., region 596 cost column 567). If no matching (or near enough matching) category is found in the portion of the financial statement identified by the drop, then a new region may be created (e.g., “other”) and the value presented in that new region.

If a drop identifies in the presentation of the financial statement a location that does not correspond to the destination category, destination subcategory, and/or destination sub-subcategory, then the drop may be completed without reference to item ID. Consequently multiple rows in the same or different lists may have the same description 581 (e.g., stock symbol).

Processes 618, 622, and 626 may perform calculations on values without regard to whether an incorrectly dropped value is included in their calculations. In an alternate implementation, these processes pass an error signal to provide guidance process 632 to alert the user that the requested calculation is in error. The cooperation of the calculating process and process 632 may further identify the incorrectly dropped value for suitable further guidance.

The foregoing description discusses preferred embodiments of the present invention which may be changed or modified without departing from the scope of the present invention as defined in the claims. While for the sake of clarity of description, several specific embodiments of the invention have been described, the scope of the invention is intended to be measured by the claims as set forth below.

What is claimed is:

1. A computer system, for permitting participation in a financial transaction, the system comprising:
means for presenting an opportunity to participate in the transaction, the opportunity comprising a plurality of values;
means for providing a financial statement that describes a financial position, the financial statement comprising a plurality of portions, the financial position comprising total periodic income, total periodic expenses, and net periodic cash flow;
means for receiving inputs from the user that specify each association of a plurality of associations, wherein each association associates a respective value of the opportunity with a respective portion of the financial statement;
means for updating the presentation of the financial statement in accordance with the plurality of associations; and
means for permitting participation in the transaction in accordance with accepting the plurality of associations.

2. A method, performed by a computer, for permitting participation in a financial transaction, the method comprising:
presenting an opportunity to participate in the transaction, the opportunity comprising a plurality of values;
providing a financial statement that describes a financial position, the financial statement comprising a plurality of portions, the financial position comprising total periodic income, total periodic expenses, and net periodic cash flow;
receiving inputs from the user that specify each association of a plurality of associations, wherein each association associates a respective value of the opportunity with a respective portion of the financial statement;
updating the presentation of the financial statement in accordance with the plurality of associations; and
permitting participation in the transaction in accordance with accepting the plurality of associations.

3. The method of claim 2 wherein accepting is performed with reference to generally accepted accounting practices.

4. The method of claim 2 wherein accepting is performed with reference to a financial strategy applicable to personal finance.

5. The method of claim 2 wherein updating comprises receiving input from the user requesting an update of a summary value of the financial statement.

6. The method of claim 2 wherein receiving inputs includes cooperating with a pointing device operated by the user wherein user operation comprises dragging beginning at the presentation of the value of the opportunity and dropping at the portion of the financial statement.

7. The method of claim 6 wherein cooperating with the pointing device further comprises presenting an animation comprising the value while dragging.

8. The method of claim 6 wherein each respective portion of the financial statement comprises a respective region of a presentation of the financial statement.

9. The method of claim 8 wherein the each respective region comprises a location visually associated with a legend.

10. The method of claim 2 wherein:
each portion of the financial statement comprises a respective location category;
each value of the opportunity comprises a set of at least one respective destination category; and
an association referring to a particular value and a particular portion is accepted when the respective location category of the particular portion of the financial statement is a member of the set of the particular value of the opportunity.

11. The method of claim 10 wherein each location category comprises first hierarchical categories.

12. The method of claim 11 wherein each destination category comprises second hierarchical categories.

13. The method of claim 12 wherein an association is accepted when the respective hierarchical categories do not completely match.

14. The method of claim 2 further comprising recognizing a transaction that brings about a change in financial position wherein total periodic passive income exceeds total periodic expenses.

15. A memory device comprising indicia of instructions for a computer to perform the method of claim 2.

16. A computer system comprising:
an output device for presenting information to a user, a presentation of the information comprising values;
an input device operative by the user to provide a signal; and
a processor coupled to the output device and to the input device for communicating with the user, wherein:
(1) the processor, in accordance with the signal, associates each value of the plurality of values with a type of value being of the set comprising periodic recurring passive income and periodic recurring expenses; and
(2) the processor provides guidance to the user in accordance with the associations, to encourage the user to classify the values according to a predefined classification or to accumulate periodic recurring passive income to exceed periodic recurring expenses.

17. The system of claim 16 wherein particular guidance is triggered by at least one of a portion of the presentation of information, a lapse of time prior completing an association, completing an association that is not consistent with the predefined classification, and completing an association that is consistent with the predefined classification.

18. A decision support computer system for use by a plurality of users to learn principles of personal finance by competing, the system comprising:
means for central processing coupled to a provided network for communication between each user and the means for central processing;
means for identifying to a particular competition a subset of the plurality of users;
means for modeling financial consequences of a respective series of decisions made by each user of the subset; and
graphical user interface means operative by each user for indicating a decision after associating values of an opportunity to portions of a financial statement; and
means for recognizing a particular user of the subset as succeeding in the particular competition in response to determining that the particular user's decisions result in the accumulation of recurring passive income exceeding recurring expenses.
